(19) United States
(12) Patent Application Publication
(10) Pub. No.: US 2026/0270125 A1
(43) Pub. Date: Sep. 10, 2026

(54) FSK FOR ULTRA-LOW POWER TRANSMITTERS

(71) Applicant: Telefonaktiebolaget LM Ericsson (publ), Stockholm (SE)

(72) Inventors: Miguel Lopez, SOLNA (SE); Andreas Höglund, SOLNA (SE); Ning He, SOLLENTUNA (SE)

(21) Appl. No.: 19/162,931

(22) PCT Filed: Mar. 8, 2023
(86) PCT No.: PCT/SE2023/050212

§ 371 Date: Sep. 6, 2025

(51) Int. Cl. H04L 27/10; H04L 5/00

(52) U.S. Cl. CPC H04L 27/10; H04L 5/0007

(57) ABSTRACT

Embodiments of a method performed by a wireless communication device for wireless transmission using Frequency Shift Keying (FSK) modulation within a frequency band or guard band of an Orthogonal Frequency Division Multiplexing (OFDM) carrier are disclosed. In one embodiment, the method comprises identifying configuration parameters for FSK modulation based on one or more parameters related to a numerology of an OFDM carrier such that the FSK modulation has continuous phase, applying the FSK modulation to an input signal in accordance with the configuration parameters identified for the FSK modulation to produce an FSK-modulated signal, and transmitting the FSK-modulated signal within either a frequency band of the OFDM carrier or a guard band of the OFDM carrier.

### TECHNICAL FIELD

The present disclosure relates to the transmission of a wireless signal by a low-powered Internet of Things (IoT) device, and reception of the wireless signal by a node of a communication network.

### BACKGROUND

Wireless Internet of Things (IoT) devices are often battery powered and power budget constraints are limiting factors for many potential applications such as asset tracking or environmental/industrial sensors. For this reason, the wireless communications industry has been interested in so-called Zero-Energy (ZE) devices. ZE devices refer to wireless IoT devices that do not require battery replacement and often harvest energy from the environment. In some use cases, such as monitoring the temperature of foodstuffs, the ZE devices may have small batteries that are disposable (e.g., organic, compostable batteries), rechargeable, or have very limited capacity.

Constant envelope modulations do not require transmission (TX) linearity and the Power Amplifier (PA) can be driven at power efficiencies larger than those achievable by non-constant envelope modulations. Moreover, constant envelope modulations often require only low-complexity digital signal processing. For these reasons, constant envelope modulations are well suited for low-power/low-cost transmitters and, in fact, are used in systems such as Bluetooth and Zigbee, where power efficiency and low cost are essential.

The Third Generation Partnership Project (3GPP) is currently considering the standardization of ZE devices, which, if successful, may lead to the deployment of massive numbers of ZE devices in the licensed spectrum, including bands below 1 Gigahertz (GHz) where the spectrum is scarce and extremely valuable. However, due to energy and cost limitations, the transmitters in ZE IoT devices are expected to support only modulation techniques having low spectrum efficiency, such as constant envelope modulations. ZE IoT devices are expected to communicate directly with network nodes such as base stations, including New Radio (NR) base stations. Hence, it is desirable to support receivers optimized for Orthogonal Frequency Division Multiplexing (OFDM) transmissions (e.g., base station radios designed to support mobile broadband services). Although in theory such a radio can receive constant envelope signals such as Gaussian Frequency Shift Keying (GFSK) (used in Bluetooth), reception would require the development of specialized software and algorithms, which is costly and time-consuming. Thus, it is desirable to develop modulation techniques that lend themselves to implementation in inexpensive, ultra-low power devices, while being suitable for multicarrier receivers and capable to co-exist with mobile broadband devices transmitting in adjacent frequencies because, for example, when designing the radio receivers of the base station, you do not want to have to take into account the signal format used by the ZE IoT devices.

### SUMMARY

Systems and methods are described for the transmission and reception of signals using Continuous Phase (CP) Frequency Shift Keying (FSK). In one embodiment, a method performed by a wireless communication device for wireless transmission using FSK modulation within a frequency band or guard band of an Orthogonal Frequency Division Multiplexing (OFDM) carrier comprises identifying configuration parameters for FSK modulation based on one or more parameters related to a numerology of an OFDM carrier such that the FSK modulation has continuous phase. The method further comprises applying the FSK modulation to an input signal in accordance with the configuration parameters identified for the FSK modulation to produce an FSK-modulated signal. The method further comprises transmitting the FSK-modulated signal within either a frequency band of the OFDM receiver or a guard band of the OFDM receiver.

The proposed modulation methods offer advantages in that they lend themselves to reception by OFDM receivers with frequency domain processing, such as those found in Fourth Generation and Fifth Generation (4G/5G) radios. They offer ease of demodulation from digital samples taken at a sampling rate determined by the OFDM air interface. That is, there is no need for digital re-sampling and the received signal is well suited for Fast Fourier Transform (FFT) based detection, where the supported FFTs are designed for the numerology of the OFDM system. Moreover, the continuous phase of the FSK modulation means the modulation methods are well suited for low-complexity, power-efficient transmitters.

In one embodiment, the configuration parameters for the FSK modulation comprise carrier frequency, symbol duration, modulation index, or any combination of two or more thereof.

In one embodiment, the configuration parameters for the FSK modulation are stored at the wireless communication device.

In one embodiment, the method comprises receiving, from a network node, signaling indicating the one or more parameters related to the numerology of the OFDM carrier.

In one embodiment, the method comprises identifying the configuration parameters for the FSK modulation from among a plurality of sets of configuration parameters stored at the wireless communication device based on the one or more parameters related to the numerology of the OFDM carrier.

In one embodiment, the method comprises computing one or more of the configuration parameters for the FSK modulation based on the one or more parameters related to the numerology of the OFDM carrier.

In one embodiment, the one or more parameters related to the numerology of the OFDM carrier comprise either or both of a subcarrier spacing and a channel raster.

In one embodiment, the configuration parameters for the FSK modulation are such that a peak frequency deviation for the FSK-modulated signal is a positive integer multiple of half a subcarrier spacing of the OFDM carrier, a product of the symbol duration of the FSK-modulated signal and the peak frequency deviation is an integer, and the carrier frequency of the FSK-modulated signal is an average of two adjacent subcarrier frequencies of the OFDM carrier.

In one embodiment, the configuration parameters for the FSK modulation are such that a peak frequency deviation for the FSK-modulated signal is one half of a subcarrier spacing of the OFDM carrier plus k times the subcarrier spacing of the OFDM carrier, wherein k is an integer that is greater than or equal to 0, and the symbol duration of the FSK-modulated signal is j times twice an OFDM symbol duration of the OFDM carrier, wherein j is an integer that is greater than or equal to 1, and the carrier frequency of the FSK-modulated signal is an average of two adjacent subcarrier frequencies of the OFDM carrier.

In one embodiment, the configuration parameters for the FSK modulation are such that a peak frequency deviation for the FSK-modulated signal is one half of a subcarrier spacing of the OFDM carrier, the symbol duration of the FSK-modulated signal is twice an OFDM symbol duration of the OFDM carrier, and the carrier frequency of the FSK-modulated signal is an average of two adjacent subcarrier frequencies of the OFDM carrier.

In one embodiment, the configuration parameters for the FSK modulation are such that a modulation alphabet for the FSK modulation is {−K_1, . . . , 0, 1, . . . , K_2} wherein K1 and K2 are non-negative, the carrier frequency of the FSK-modulated signal is equal to a center frequency of one of a plurality of subcarriers of the OFDM carrier, and the modulation index for the FSK-modulated signal is even, and the symbol duration of the FSK-modulated signal is a multiple of an OFDM symbol duration of the OFDM carrier.

In one embodiment, the configuration parameters for the FSK modulation are such that a modulation alphabet for the FSK modulation is {0,1}, the carrier frequency of the FSK-modulated signal is equal to a center frequency of one of a plurality of subcarriers of the OFDM carrier, the modulation index for the FSK-modulated signal is even, and the symbol duration of the FSK-modulated signal is a multiple of an OFDM symbol duration of the OFDM carrier.

In one embodiment, transmitting the FSK-modulated signal comprises transmitting at a reduced level the FSK-modulated signal during a subset of signaling periods based on a symbol being transmitted.

In one embodiment the symbol being transmitted during the subset of signaling periods is a “0”.

In one embodiment, the method further comprises transmitting without applying the reduction in level of the FSK-modulated signal during other signaling periods not included in the subset of signaling periods, wherein other symbols transmitted during the other signaling periods correspond to a “1” and are varied over the other signaling periods.

In one embodiment, the wireless communication device is one of a plurality of wireless communication devices transmitting to an OFDM receiver in the frequency band or guard band of the OFDM carrier, and a portion of the frequency band or guard band of the OFDM carrier in which the FSK-modulated signal is transmitted is based on a frequency synchronization accuracy of the wireless communication device.

In one embodiment, a method performed by a network node comprising an OFDM receiver for wireless reception using FSK modulation within a frequency band or guard band of an OFDM carrier, the method comprises receiving, from a wireless communication device via the OFDM receiver, an FSK-modulated signal within either a frequency band of the OFDM carrier or a guard band of the OFDM carrier, wherein the FSK-modulated signal is modulated in accordance with a continuous phase FSK modulation scheme having one or more configuration parameters that are based on one or more parameters related to a numerology of the OFDM carrier, and applying FSK demodulation to the FSK-modulated signal to produce an output signal.

In one embodiment the method further comprises transmitting signaling indicating the one or more parameters related to the numerology of the OFDM carrier to the wireless communication device to enable the wireless communication device to identify the one or more configuration parameters for the continuous phase FSK modulation scheme.

In one embodiment the method further comprises transmitting signaling indicating the one or more parameters related to the numerology of the OFDM receiver to a network node.

In one embodiment a portion of the frequency band or guard band of the OFDM carrier in which the FSK-modulated signal is received is based on a frequency synchronization accuracy of a wireless communication device.

In one embodiment the wireless communication device is one of a plurality of wireless communication devices and the plurality of wireless communication devices is divided into two or more groups based on the frequency synchronization accuracy of the wireless communication device of the plurality of wireless communication devices, wherein the two or more groups are assigned to different portions of the frequency band of the OFDM carrier.

In one embodiment the two or more groups are separated in frequency by one or more guard bands.

In one embodiment a first group of the two or more groups includes wireless communication devices with a frequency synchronization accuracy less than C1 parts per million (ppm), a second group of the two or more groups includes wireless communication devices with a frequency synchronization accuracy greater than or equal to C1 ppm and less than C2 ppm, and a third group of the two or more groups includes wireless communication devices with a frequency synchronization accuracy greater than C2 ppm.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a system architecture for using Continuous P Phase (CP) Frequency Shift Keying (CP-FSK) modulation over Orthogonal Frequency Division Multiplexing (OFDM);

FIG. 2 illustrates a 2-CPFSK signal with the horizontal axis representing the OFDM grid in the frequency domain according to various embodiments of the present disclosure;

FIG. 3 illustrates a Continuous Phase Modulation (CPM) signal with the horizontal axis representing the OFDM grid in the frequency domain and the square indicating the carrier frequency with q=1 according to various embodiments of the present disclosure;

FIG. 4 illustrates the use of hybrid FSK modulation according to various embodiments of the present disclosure;

FIG. 5 illustrates the frequency domain multiplexing of Internet of Things (IoT) devices and mobile broadband devices;

FIG. 6 illustrates the approximate orthogonality between a CPM signal and an OFDM signal according to various embodiments of the present disclosure;

FIG. 7 illustrates a simplified FSK transmitter system using FSK modulation according to various embodiments of the present disclosure;

FIG. 8 illustrates a simplified OFDM receiver system using FSK modulation according to various embodiments of the present disclosure;

FIG. 9A illustrates a flowchart of the method steps for signal transmission using CP-FSK modulation over OFDM according to various embodiments of the present disclosure;

FIG. 9B illustrates a flowchart of additional method steps for signal transmission using CP-FSK modulation over OFDM according to various embodiments of the present disclosure;

FIG. 10 is a schematic block diagram of a wireless communication device according to some embodiments of the present disclosure;

FIG. 11 is a schematic block diagram of the wireless communication device of FIG. 10 according to some other embodiments of the present disclosure;

FIG. 12 is a schematic block diagram of a node device according to some embodiments of the present disclosure; and

FIG. 13 is a schematic block diagram of the node device of FIG. 12 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may be a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, the UE is scheduled by the same DCI for both TRPs, and in multi-DCI mode the UE is scheduled by independent DCIs from each TRP.

Orthogonal Frequency-Division Multiplexing (OFDM): As used herein, OFDM is a type of digital transmission and a method of encoding digital data on multiple carrier frequencies. In OFDM, multiple closely spaced orthogonal subcarrier signals with overlapping spectra are transmitted to carry data in parallel. Demodulation is based on fast Fourier transform algorithms. Each subcarrier (signal) is modulated with a conventional modulation scheme (such as quadrature amplitude modulation or phase-shift keying) at a low symbol rate. The present disclosure introduces the use of Frequency-Shift Keying (FSK) as the modulation scheme.

FSK: As used herein, FSK is a frequency modulation scheme in which digital information is encoded on a carrier signal by periodically shifting the frequency of the carrier between several discrete frequencies. The simplest FSK is binary FSK (BFSK or 2-FSK), in which the carrier is shifted between two discrete frequencies to transmit binary (0s and 1s) information. A design consideration with FSK involves dealing with the phase discontinuity when switching between the several discrete transmission frequencies. In general, the two frequencies will not be at the same phase and, therefore, the same amplitude at the switch-over instant, causing sudden discontinuities in the transmitted signal. The elimination of discontinuities in the phase (and therefore elimination of sudden changes in amplitude) reduces sideband power, reducing interference with neighboring channels.

Continuous Phase Modulation (CPM): As used herein, CPM is a method for modulation of data commonly used in wireless modems. In contrast to other coherent digital phase modulation techniques where the carrier phase abruptly resets to zero at the start of every symbol, with CPM the carrier phase is modulated in a continuous manner. For instance, with Quadrature Phase Shift Keying (QPSK) the carrier instantaneously jumps from a sine to a cosine (i.e., a 90-degree phase shift) whenever one of the two message bits of the current symbol differs from the two message bits of the previous symbol. This discontinuity requires a relatively large percentage of the power to occur outside of the intended band (e.g., high fractional out-of-band power), leading to poor spectral efficiency. Furthermore, CPM is typically implemented as a constant-envelope waveform, i.e. the transmitted carrier power is constant. Therefore, CPM is attractive because the phase continuity yields high spectral efficiency, and the constant envelope yields excellent power efficiency.

Cellular networks are constantly evolving and hence it is advantageous to design the modulations and air interface for ultra-low power IoT devices offering flexibility to evolve the device ecosystem without a need to redesign the air interface. For example, if future IoT devices can achieve moderately accurate frequency synchronization (e.g., better than 1 part per million (ppm)) while keeping the cost and power consumption low, then the present disclosure enables improved spectrum usage by allowing OFDM of these IoT devices. In this same scenario, near-frequency domain orthogonality can be obtained between signals transmitted by the IoT device and signals transmitted in adjacent frequencies by OFDM transmitters so that interference to mobile broadband signals is also mitigated, i.e. it would ensure the IoT system has good co-existence within existing Mobile Broadband (MBB) systems.

The techniques described herein deal with ultra-low power transmissions. The techniques introduce variants of FSK which can be implemented in power-efficient transmitters and are well suited for one multicarrier receiver receiving these signals concurrently together with MBB OFDM signals (i.e., in the base station receiver).

An FSK signal is generated by frequency shifting a carrier with frequency F_{c} by an amount Δf/2 aₙ, aₙ∈{±1, ±3, . . . , ±(2K−1)}. The set {±1, 3, . . . , ±(2K−1)} is called the modulation alphabet, and the coefficients aₙ are called modulation symbols. There are 2K symbols in the modulation alphabet and the modulation is often called 2K-FSK. It is very common to choose 2K=2\hat{ }M so that a sequence of M bits can be mapped one-to-one to each of the 2\hat{ }M modulation symbols in the modulation alphabet. The most widely used variant is 2-FSK (i.e., K=M=1). During the n-th signaling period of duration T seconds, the transmitter sends a tone with frequency F_{c}+Δf/2 aₙ so that the data rate is M/T bits per second (bps). A problem with FSK is that the switch from one frequency to another causes the phase of the signal to “jump” and generate undesirable high frequency components.

Continuous Phase FSK (CPFSK) is a modification of FSK where the phase of the transmitted signal is changed continuously, thus reducing unwanted spectral sidelobes. During the n-th signaling period of duration T seconds, the phase φ of a CPFSK signal can be written in the form:

$$φ ( t ; \{ {a}_{n} \} ) = 2 π {f}_{d} {a}_{n} ( t - nT ) + 2 π {f}_{d} T {\sum }_{k < n} {a}_{k} , nT \leq t \leq ( n + 1 ) T .$$

The corresponding baseband signal is x_{bb}(t)=exp(jφ(t;{aₙ})) and the transmitted passband signal is x_{RF}(t)=Re(x_{bb}(t)exp(j2πF_{c})). The term f_{d} is called the peak frequency deviation.

The quantity h=2f_{d} T is called the modulation index. One can rewrite the expression for the phase of a CPFSK signal in the form:

$$φ ( t ; \{ {a}_{n} \} ) = π h {\sum }_{k \leq n} {a}_{k} p ( t - k T ) , n T \leq t \leq ( n + 1 ) T ,$$

where p(t) is called the phase pulse and is defined by:

$$p ( t ) = \{ \begin{matrix}0 & ( t < 0 \\ \frac{t}{T} & ( 0 \leq t \leq T ) \\ 1 & ( T < t )\end{matrix} .$$

The pulse p(t) is often called LREC in the literature.

If the LREC pulse p(t) above is replaced by a continuous increasing function that is 0 for t<0 and 1 for t>L·T, L≥1, then the resulting modulation is called CPM with modulation index h. There are many well-known phase pulses, such as the Gaussian Minimum Shift Keying (GMSK) pulse used in Global System for Mobile Communications (GSM), which are used when the spectral sidelobe suppression given by the LREC pulse is not enough. Thus, CPFSK can be seen as a particular case of CPM and also as a particular case of FSK.

When designing an air interface for power constrained IoT devices operating in a cellular network, it is important to consider deployment scenarios where there can be other IoT devices and broadband UEs transmitting simultaneously in adjacent frequency bands. Furthermore, OFDM is the basis of the NR air interface and is likely to be used in future generation cellular systems, and the base station receivers are often optimized for frequency domain processing with the NR numerology.

Consider an OFDM system that has a center frequency F₀ and utilizes a subcarrier spacing ΔF. The center frequencies of the subcarriers are of the form F₀+mAF. The Discrete Fourier Transform (DFT) at the receiver correlates the received signals with complex sinusoids of the form exp(j2πmΔFt), 0≤t≤1/ΔF. The duration T_{OFDM}=1/ΔF is called the OFDM symbol duration. Note that these complex sinusoids have frequencies which are integer multiples of ΔF (m is an integer that can be positive, negative, or zero), and which have a duration such that their phase revolves an integer number of times |m| around the unit circle. The analysis of signals in the frequency domain is based on the following well-known orthogonality principle. If the received signal has a component with frequency that is a multiple n of ΔF and whose phase changes linearly in time and revolves an integer number of times around the unit circle during a time interval whose duration is a multiple of T_{OFDM}, then this component will be orthogonal to a sinusoid exp(j2πmΔFt), unless m=n.

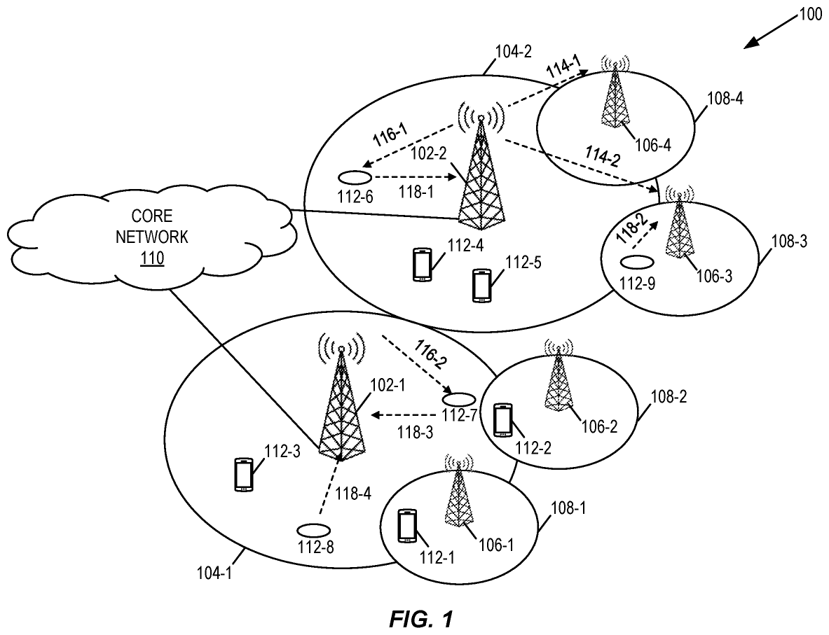

FIG. 1 illustrates one example of a system architecture for using CPFSK modulation over OFDM. In the embodiments described herein, a cellular communications system 100 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC) and any system capable to receive OFDM signals, like Sixth Generation (6G). In this example, the RAN includes base stations 102-1 and 102-2, and controls corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), an OFDM capable UE operating in sidelink as a receiver to receive a Zero-Energy (ZE) signal, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5GC. The base stations 102 (and optionally the low power nodes 106) are connected to the core network 110.

The base stations 102 and the low power nodes 106 provide service to wireless communication devices 112-1 through 112-9 in the corresponding cells 104 and 108. The wireless communication devices 112-1 through 112-9 are generally referred to herein collectively as wireless communication devices 112 and individually as wireless communication device 112. In the following description, the wireless communication devices 112-1 through 112-5 are oftentimes UEs and the wireless communication devices 112-6 through 112-9 are ultra-low-power IoT devices, but the present disclosure is not limited thereto.

The base stations 102 provide parameters 114 identifying the numerology of an OFDM receiver at the base stations 102 to other base stations 102. The base stations 102 also provide the same parameters 116 identifying the numerology of the OFDM receiver at the base stations 102 to the wireless communication devices 112-6 through 112-9. The wireless communication devices 112-6 through 112-9 use the parameters 114 and 116 identifying the numerology of the OFDM receiver at the base stations 102 to identify configuration parameters for FSK modulation with continuous phase. The wireless communication devices 112-6 through 112-9 transmit FSK-modulated signals 118 to the base stations 102 using FSK modulation with continuous phase based on the configuration parameters.

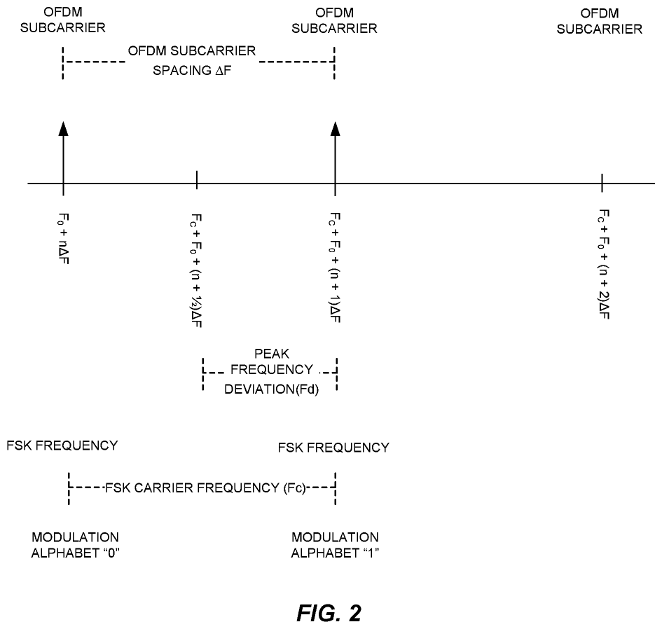

FIG. 2 illustrates a 2-CPFSK signal with the horizontal axis representing the OFDM grid in the frequency domain according to an example of a first embodiment of the present disclosure. From an OFDM perspective, frequencies F₀+nΔF, F₀+(n+1)ΔF, and F₀+(n+2)ΔF correspond to OFDM subcarriers having a subcarrier spacing ΔF. From an FSK perspective, frequencies F₀+nΔF and F₀+(n+1)ΔF correspond to FSK frequencies for FSK modulation alphabet “0” and FSK modulation alphabet “1” (as indicated by the vertical arrows in FIG. 2) and are centered around an FSK center frequency

$${F}_{c} = {F}_{0} + ( n + \frac{1}{2} ) .$$

The peak frequency deviation (f_{d}) for this FSK modulation is

$$\frac{Δ F}{2} .$$

In this first embodiment using 2-CPFSK modulation, there are three parameters: the carrier frequency F_{c}, the peak frequency deviation f_{d}, and the symbol duration T. In one embodiment of the disclosure, these parameters are chosen as follows:
The peak frequency deviation for the FSK-modulated signal is one half of the subcarrier spacing of the OFDM receiver:

$${f}_{d} = \frac{Δ F}{2}$$

The symbol duration of the FSK-modulated signal is twice the OFDM symbol duration:

$$T = 2 {T}_{O F D M} = \frac{2}{Δ F}$$

The carrier frequency of the FSK-modulated signal is the average of two adjacent subcarrier frequencies of the OFDM receiver:

$${F}_{c} = {F}_{0} + ( n + \frac{1}{2} )$$

ΔF for some n.

The above parameters can be generalized as:
a peak frequency deviation for the FSK-modulated signal is one half of a subcarrier spacing of the OFDM carrier plus k times the subcarrier spacing of the OFDM carrier, wherein k is an integer that is greater than or equal to 0
the symbol duration of the FSK-modulated signal is j times twice an OFDM symbol duration of the OFDM carrier, wherein j is an integer that is greater than or equal to 1
the carrier frequency of the FSK-modulated signal is an average of two adjacent subcarrier frequencies of the OFDM carrier

With these parameter choices, the 2-FSK has continuous phase and is in fact, 2-CPFSK. 2-FSK typically has a jumping/discontinuous phase when switching between frequencies represented by 0 and 1. This selection of parameter values will cause the phases to match at these switches so that there is no phase discontinuity. Moreover, the two frequencies have center frequencies coinciding with adjacent subcarriers in the OFDM system, and their phases revolve exactly once around the unit circle during the duration T of the symbol.

In fact, if the three conditions above are satisfied and FSK modulation symbols are chosen from a modulation alphabet of order 2K then 2K-CPFSK is generated, and the 2K tones will be orthogonal to complex sinusoids of the form exp(j2πmΔFt), 0≤t≤2T_{OFDM}.

The modulation can be generalized to 2K-FSK by requiring that:
The peak frequency deviation for the FSK-modulated signal is a positive integer multiple of half the subcarrier spacing of the OFDM receiver

$${f}_{d} = \frac{k Δ F}{2}$$

The product of the symbol duration of the FSK-modulated signal and the peak frequency deviation is an integer:
f_{d}T=q for some integer q.
The carrier frequency of the FSK-modulated signal is the average of two adjacent subcarrier frequencies of the OFDM receiver:

$${F}_{c} = {F}_{0} + ( n + \frac{1}{2} )$$

ΔF for some n.

As before, if the FSK modulation symbols are chosen from a modulation alphabet of order 2K, then the design points immediately above ensure that 2K-CPFSK is generated and the 2K tones will be orthogonal to complex sinusoids of the form exp(j2πmΔFt), 0≤t≤2T_{OFDM}.

In terms of the CPM description of CPFSK, the modulation index is h=2f_{d}T=2q. If increased suppression of spectral sidelobes is desired, then the phase pulse can be changed from LREC to another pulse such as the GMSK phase pulse. The cost is a degradation in the orthogonality among the tones.

Advantages of this type of FSK are that it lends to processing using a frequency domain receiver based on the OFDM numerology and, that if the IoT transmitters are not too inaccurate then they can be multiplexed orthogonally in the frequency domain, giving better spectrum utilization than alternatives such as Frequency Division Multiple Access (FDMA). For example, a ZE-IoT system (carrier) may be deployed inside a NR carrier (i.e., in-band operation) reusing the same hardware and receiver in the base station.

As discussed previously, the FSK configuration to achieve CPM is based on the OFDM configuration (center frequency, subcarrier spacing, etc.). In one embodiment, the ZE-IoT UEs is be pre-configured to use certain predefined values for the FSK modulation. In other embodiments, the system broadcasts configuration information to the ZE-IoT UEs over the network. In another embodiment, the FSK configuration for the ZE-IoT UEs is identified by the center frequency and subcarrier spacing for the OFDM system in ZE-IoT system information and a mapping of different OFDM configurations to the suitable ZE-IoT FSK configurations is defined, e.g., in the ZE-IoT specification. In another embodiment, an explicit configuration index is used, which points to an FSK configuration in the ZE-IoT specification (i.e., a table of possible FSK configurations with the associated indexes would be provided in the specification). In a third embodiment, the parameters for the FSK configuration are explicitly configured in ZE-IoT system information.

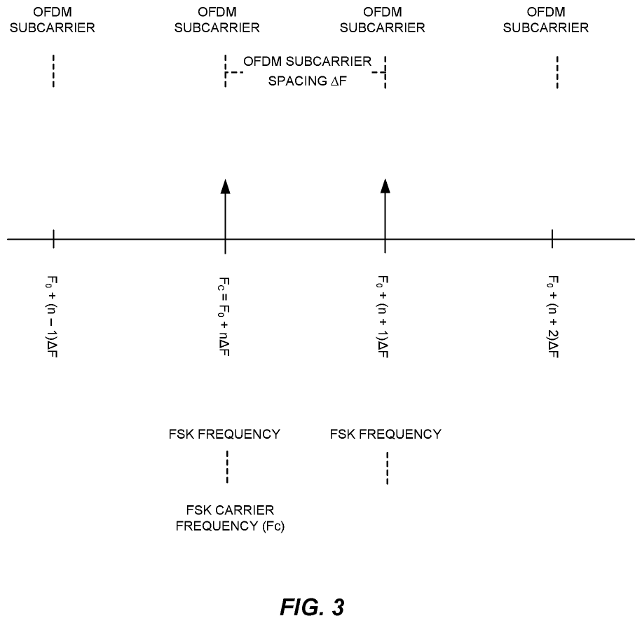

FIG. 3 illustrates a CPM signal with the horizontal axis representing the OFDM grid in the frequency domain and the square indicating the carrier frequency Fc with q from the bullets below chosen as q=1 according to an example of a second embodiment of the present disclosure. In this second embodiment, the use of CPM again guarantees continuous phase but now carrier frequency Fc is at an OFDM subcarrier instead of being in between OFDM subcarriers as in the first embodiment exemplified in FIG. 2. From an OFDM perspective, frequencies F₀+(n−1)ΔF, F₀+nΔF, F₀+(n+1)ΔF, and F₀+(n+2)ΔF correspond to OFDM subcarriers having a subcarrier spacing ΔF. From a FSK perspective, frequencies F₀+nΔF and F₀+(n+1)ΔF correspond to FSK frequencies for FSK modulation (as indicated by the vertical arrows in FIG. 3). The modulation alphabet of CPM is generally taken to be {±1, ±3, . . . , ±(2K−1)}. However, it is possible to choose another modulation alphabet. The transmitter generates a CPM signal with the following characteristics:
The modulation alphabet for the FSK modulation is {0,1}.
The carrier frequency for the FSK-modulated signal is equal to the center frequency of one of the subcarriers of the OFDM receiver: F_{c}=F₀+nΔF for some n.
The modulation index for the FSK-modulated signal is even: h=2q for some positive integer q. A recommended choice is q=1 to obtain the narrowest signal bandwidth.
The symbol duration for the FSK-modulated signal is a multiple to the OFDM symbol duration of the OFDM receiver: T=m T_{OFDM}.

To understand the properties of this CPM, consider again the LREC pulse. When the modulation symbol is 0, the baseband signal is a Direct Current (DC) component: x_{bb}(t)=1 and the passband signal is a tone at the carrier frequency. When the modulation symbol is 1, the baseband signal is a complex sinusoid of the form exp(j2πqΔFt), 0≤t≤mT_{OFDM} and the passband signal is a tone at frequency F_{c}=F₀+q ΔF.

This modulation can be generalized by enlarging the modulation alphabet to {−K₁, . . . , 0, 1, . . . , K₂} where K₁ and K₂ are non-negative integers (e.g. {−1,0,1,2} or {−1,0,1,2}). This means that more tones can be used, expanding the signal bandwidth and data rates.

Advantages of this type of CPM are that it lends to processing using a frequency domain receiver based on the OFDM numerology, and that if the IoT transmitters are not too inaccurate then they can be multiplexed orthogonally in the frequency domain, giving better spectrum utilization than alternatives such as FDMA. Moreover, the CPM signals can be tuned to control the interference on OFDM signals in adjacent channels. These CPM signals can also be designed to provide orthogonality to OFDM signals as exemplified in the third embodiment.

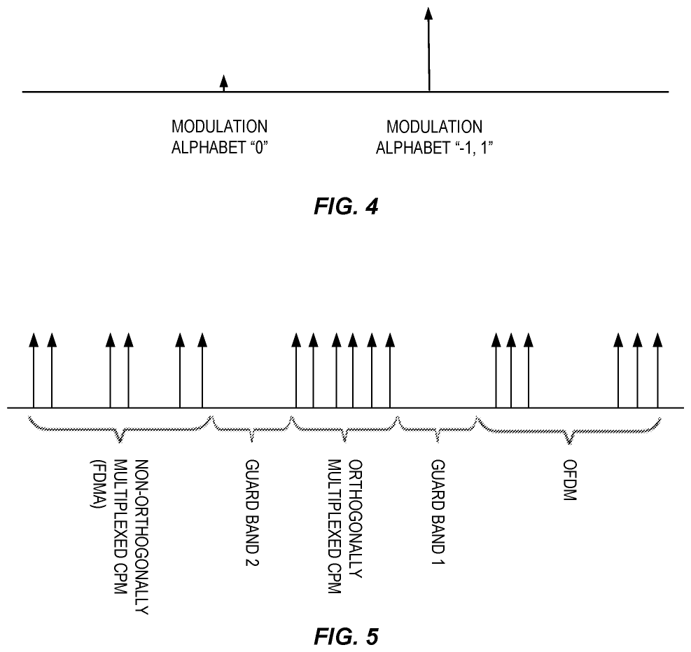

FIG. 4 illustrates the use of hybrid FSK modulation according to an example of a third embodiment of the present disclosure. In this third embodiment of the present disclosure a CPM as described in the first or second embodiments is combined with On-Off Keying (OOK) as follows. The modulation parameters (carrier frequency F_{c}, signaling period T, etc.) are chosen according to either of the first or second embodiments. The transmitted signal can be selectively muted during some of the signaling periods depending on the data bits. Note that muting the signal does not mean reducing the signal to zero. A non-zero signal is transmitted such that phase continuity can be maintained when transmitting the symbol/bit 0. In one embodiment, a logical 0 corresponds to the transmitter being muted (i.e., reduced signal is transmitted, off), while a logical 1 corresponds to some signal being transmitted (on). In this case the FSK modulation symbols an do not carry information. The advantage of this type of modulation is that during the off periods there is no interference to other signals in adjacent channels. During the on periods the FSK modulation symbols can be randomized to provide frequency diversity. That is, OOK is used for modulation and data transmission, and FSK is used to average or spread the interference. In another embodiment the FSK modulation symbols an do carry information. The logical bits are mapped to a combination of on/off and frequency shifts. For example, the CPM can be as in the second embodiment with modulation alphabet {-1,0,1}. Then, during each signaling period there are four possibilities for the transmitted waveform: off (nothing is transmitted) or three different frequencies corresponding to each of the three modulation symbols. Pairs of data bits can be mapped one-to-one to these four waveforms.

In regard to a fourth embodiment of the present disclosure, FIG. 5 illustrates the frequency domain multiplexing of IoT devices and MBB devices. Suppose that three types of devices operate concurrently in uplink: MBB with high-frequency accuracy (frequency error <0.1 ppm (C₁)), low power IoT class 1 with moderate frequency accuracy (e.g., frequency error <1 ppm (C₂)), and low power IoT class 2 with poor frequency accuracy (e.g., frequency error >1 ppm (C₂)). If the class 1 IoT devices employ modulations as described in the embodiments above, then they can be multiplexed orthogonally in the frequency domain. Moreover, the interference of these devices towards adjacent OFDM devices is less than the interference from class 2 IoT devices. Hence, it is advantageous to locate them adjacent in frequency to the OFDM devices because the guard band needed is smaller than if class 2 IoT devices were adjacent. Moreover, some OFDM transmissions require very high Signal to Interference and Noise Ratio (SINR) to reach very high data rates, while class 1 IoT devices typically operate at low/moderate SINR. Hence class 1 IoT devices can tolerate more interference than OFDM devices from class 2 IoT devices. In summary, it is advantageous to group (in frequency) the IoT devices according to their class, with the class 1 IoT devices orthogonally multiplexed and located between the class 2 IoT devices and OFDM devices as illustrated in FIG. 5.

In another embodiment, the same device may operate as class 1 or class 2 IoT device, depending on its power state. For example, a first energy harvesting device may have access to a strong energy source, while a second device in the same network may only have access to a weak energy source, depending on the particular locations of the devices. For example, in the case of Radio Frequency (RF) energy harvesting, a device located close to the carrier emitter may have access to a power source several tens of decibels (dB) stronger than a device located far from the carrier emitter. The devices may have two Local Oscillators (LOs) and select the LO based on the power availability. In one embodiment of the present disclosure the network queries the device's capabilities and power state and decides the operating class of the device. In another embodiment, the device autonomously decides its class depending on the power availability. In yet another embodiment, the network may signal a device to select a minimum LO class based on the intended subcarrier/frequency allocation.

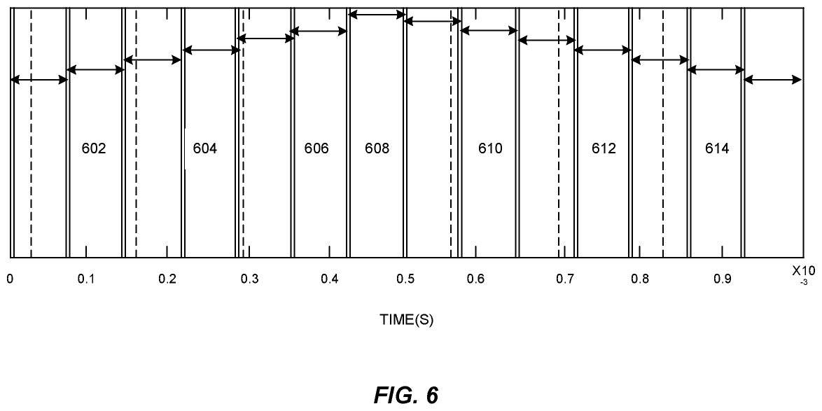

FIG. 6 illustrates the approximate orthogonality between a CPM signal and an OFDM signal according to various embodiments of the present disclosure. In FIG. 6, the solid vertical lines represent the OFDM or CP boundaries of a 1 millisecond (ms) frame in an NR OFDM system. The dashed lines represent the symbol boundaries of a CPM signal according to the present disclosure. The CPM signal is not time synchronized to the OFDM time grid (it has a random time offset). In this example, the NR OFDM symbols labeled 602-614 are orthogonal in the frequency domain to the CPM signal.

As an example, consider an OFDM system based on the NR numerology with 15 kilohertz (kHz) subcarrier spacing. Suppose that a CPM signal is generated according to the second embodiment with q=1 and m=2. This means that the CPM signal comprises two or more subcarriers with center frequencies falling on the OFDM frequency grid, and the signaling period is twice the OFDM symbol duration: T=2T_{OFDM}=12.3 μs. Finally, suppose that the CPM signal is not time synchronized to the OFDM time grid. The symbol boundaries and the OFDM grid are illustrated in FIG. 6. In FIG. 6, the duration of each OFDM symbol, including the cyclic prefix, is shown by a double arrow. It follows that if the CPM signal is frequency synchronized to the OFDM system, then 7 out of 14 OFDM symbols in a 1 ms subframe will be orthogonal in the frequency domain to the CPM signal.

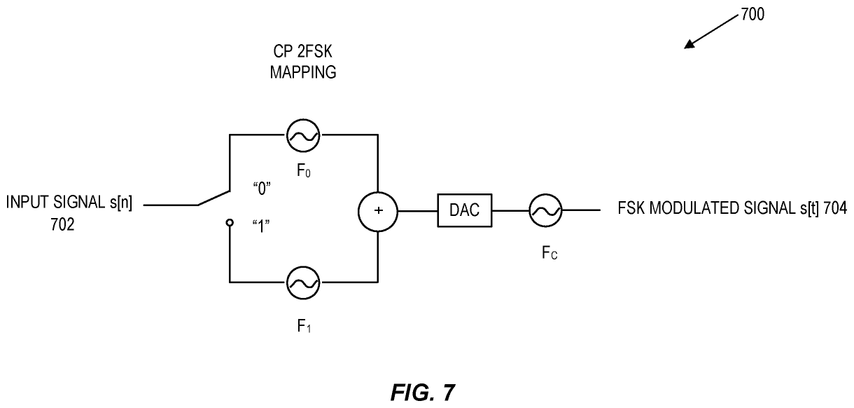

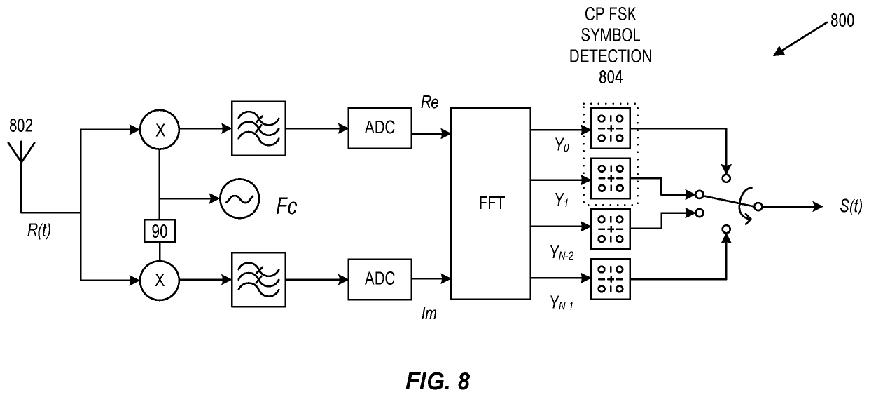

FIG. 7 illustrates a simplified FSK transmitter system using FSK modulation according to various embodiments of the present disclosure. FSK is a frequency modulation scheme in which digital information is encoded on a carrier signal by periodically shifting the frequency of the carrier between several discrete frequencies. In the example shown in FIG. 7, a 2-FSK transmitter 700 is shown, using two frequencies F₀ and F₁. The configuration parameters of the 2-FSK system are chosen based on the numerology of an OFDM receiver, such as the OFDM receiver 800 of FIG. 8, such that the 2-FSK transmitter 700 has continuous phase, thus making the system 2-CPFSK. The two frequencies, F₀ and F₁, are summed and converted from digital to analog for over-the-air transmission. An input signal 702 is modulated using carrier frequency F_{c} to produce an FSK-modulated signal 704. While the CP-FSK transmitter of FIG. 7 is shown using two frequencies, the system is not limited thereto. The system may be designed under any combinations shown in embodiments one through four.

FIG. 8 illustrates an example of a simplified OFDM receiver 800 system using FSK modulation according to various embodiments of the present disclosure. The receiver picks up a signal r(t) 802, which is then quadrature-mixed down to baseband using cosine and sine waves at the carrier frequency. This also creates signals centered on 2f_{c}, so low-pass filters are used to reject these. The baseband signals are then sampled and digitized using Analog-to-Digital Converters (ADCs), and a forward Fast Fourier Transform (FFT) is used to convert back to the frequency domain. This returns N parallel streams, each of which is converted to a binary stream using an appropriate symbol detector. The present disclosure teaches techniques where the N parallel streams are broken into subgroups, such as CP FSK symbol detection group 804, and an FSK modulated signal from a wireless communication device 112 is reconstructed.

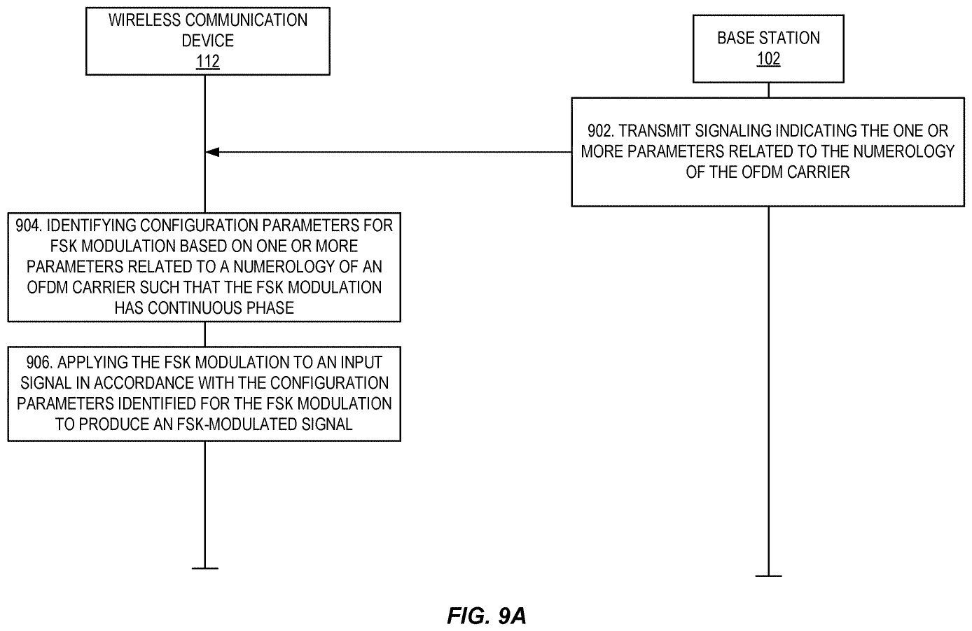

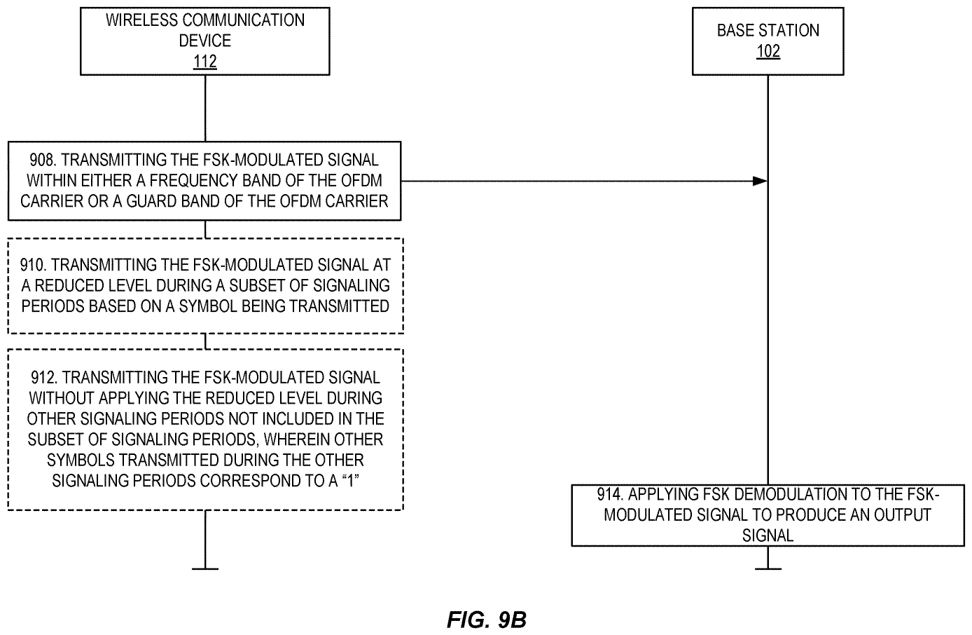

FIG. 9A illustrates a flowchart illustrating the operation of a wireless communication device 112 for signal transmission using CP-FSK modulation over OFDM according to various embodiments of the present disclosure. Although the method steps are described in conjunction with the systems of FIGS. 1-8, persons of ordinary skill in the art will understand that any system configured to perform the method steps, in any order, is within the scope of the present disclosure.

As shown in FIG. 9A, the method begins at step 902 where the base station 102 transmits signaling indicating one or more parameters related to a numerology of an OFDM carrier to a wireless communication device 112 to enable the plurality of wireless communication devices 112 to identify configuration parameters for FSK modulation with continuous phase. The configuration parameters for the FSK modulation may for example include carrier frequency, symbol duration, modulation index, or any combination of two or more thereof. The one or more parameters related to the numerology of the OFDM carrier may for example include either or both of a subcarrier spacing and a channel raster.

At step 904 the wireless communication device 112 identifies configuration parameters for FSK modulation based on one or more parameters related to a numerology of an OFDM carrier such that the FSK modulation has continuous phase. In some embodiments, the configuration parameters for FSK modulation are computed based on the parameters related to the numerology of the OFDM carrier. In some embodiments, the configuration parameters for FSK modulation are retrieved from storage at the wireless communication device 112 based on the parameters related to the numerology of the OFDM carrier.

At step 906, the wireless communication device 112 applies the FSK modulation to an input signal in accordance with the configuration parameters identified for the FSK modulation to produce an FSK-modulated signal. In some embodiments, the input signal is modulated according to the CP FSK transmitter 700 of FIG. 7. In various embodiments, the CP FSK transmitter 700 of FIG. 7 is configured based on embodiments one, two, or three described above with reference to FIGS. 2-4.

FIG. 9B illustrates a flowchart of additional method steps for signal transmission using CP-FSK modulation over OFDM according to various embodiments of the present disclosure. At step 908, the wireless communication device 112 transmits the FSK-modulated signal within either a frequency band of the OFDM carrier or a guard band of the OFDM carrier.

At step 910, the wireless communication device 112 optionally makes use of OOK to transmit the FSK-modulated signal at a reduced level during a subset of signaling periods based on a symbol being transmitted. The use of OOK is further described above with reference to FIG. 4.

At step 912, the wireless communication device 112 optionally makes use of OOK to transmit the FSK-modulated signal without reduction in level during other signaling periods not included in the subset of signaling periods, wherein other symbols transmitted during the other signaling periods correspond to a “1” and are varied over the other signaling periods. The use of OOK is further described above with reference to FIG. 4.

At step 914, the OFDM receiver device applies FSK demodulation to the FSK-modulated signal to produce an output signal. The OFDM receiver can receive signals from multiple wireless communication devices 112 at the same time. The multiple wireless communication devices 112 are included with subsets of bands within the OFDM receiver structure.

As an example, the structure of the OFDM receiver is shown in FIG. 8. The OFDM receiver 800 decodes the signal received at the antennae to produce FSK symbols on at least some of the FFT outputs. The FSK symbols are used to reconstruct the input signal applied to the CP FSK transmitter at the wireless communication device 112.

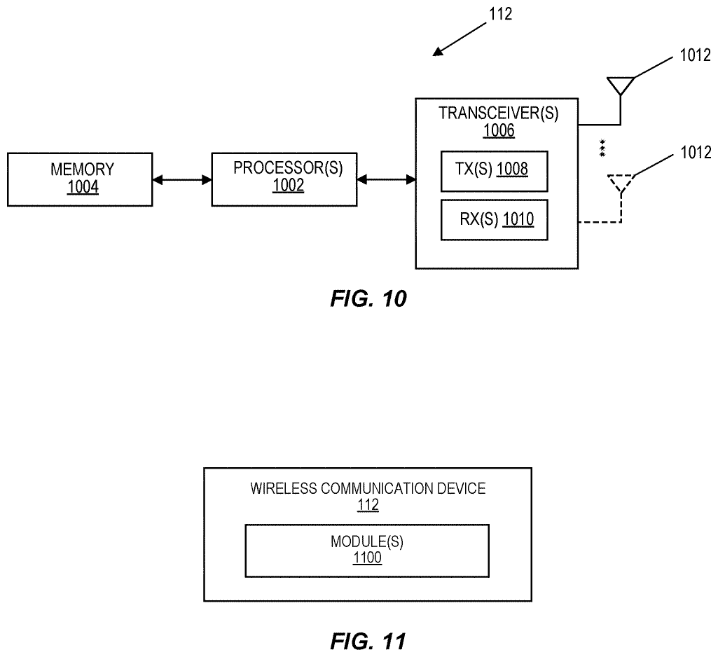

FIG. 10 is a schematic block diagram of a wireless communication device 112 according to some embodiments of the present disclosure. As illustrated, the wireless communication devices 112 includes one or more processors 1002 (e.g., Central Processing Units (CPUs), Application Specific Integrated Circuits (ASICs), Field Programmable Gate Arrays (FPGAs), and/or the like), memory 1004, and one or more transceivers 1006 each including one or more transmitters 1008 and one or more receivers 1010 coupled to one or more antennas 1012. The processors 1002 are also referred to herein as processing circuitry. The transceivers 1006 are also referred to herein as radio circuitry. In some embodiments, the functionality of the wireless communication device 112 described above may be fully or partially implemented in software that is, e.g., stored in the memory 1004 and executed by the processor(s) 1002 or implemented in hardware or a combination of hardware. Note that the wireless communication device 112 may include additional components not illustrated in FIG. 10 such as, e.g., one or more user interface components (e.g., an input/output interface including a display, buttons, a touch screen, a microphone, a speaker(s), and/or the like and/or any other components for allowing input of information into the wireless communication device 112 and/or allowing output of information from the wireless communication device 112), a power supply (e.g., a battery and associated power circuitry), etc. In some embodiments, a computer program including instructions which, when executed by at least one processor, causes the at least one processor to carry out the functionality of the wireless communication devices 112 according to any of the embodiments described herein is provided. In some embodiments, a carrier comprising the aforementioned computer program product is provided. The carrier is one of an electronic signal, an optical signal, a radio signal, or a computer-readable storage medium (e.g., a non-transitory computer-readable medium such as memory).

FIG. 11 is a schematic block diagram of the wireless communication device 112 according to some other embodiments of the present disclosure. The wireless communication device 112 includes one or more modules 1100, each of which is implemented in software. The module(s) 1100 provide the functionality of the wireless communication devices 112 described herein.

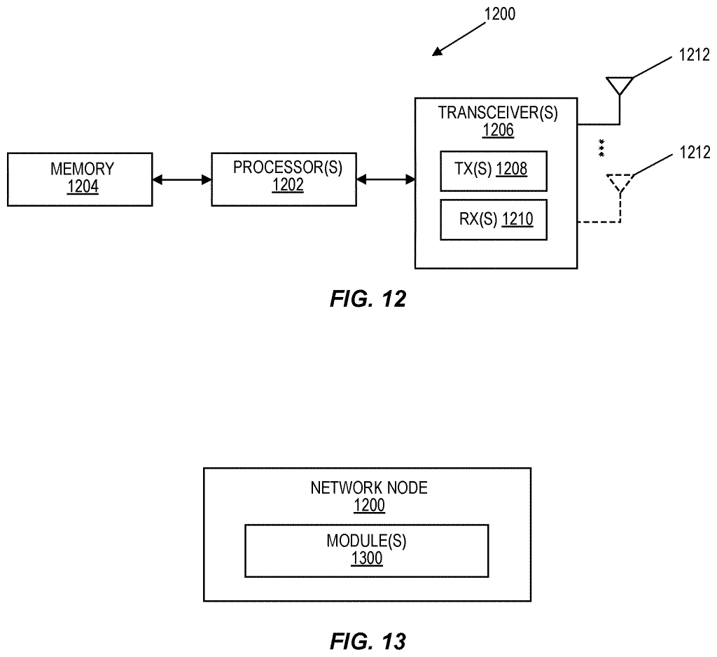

FIG. 12 is a schematic block diagram of a network node 1200 according to some embodiments of the present disclosure. The network node 1200 can be a base station 102 or a network node that performs part of the functionality of the base station 102 (e.g., a gNB-DU). As illustrated, the network node 1200 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The processors 1202 are also referred to herein as processing circuitry. The transceivers 1206 are also referred to herein as radio circuitry. In some embodiments, the functionality of network node 1200 described above may be fully or partially implemented in software that is, e.g., stored in the memory 1204 and executed by the processor(s) 1202 or implemented in hardware or a combination of hardware. Note that the network node 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the network node and/or allowing output of information from the network node), a power supply (e.g., a battery and associated power circuitry), etc. In some embodiments, a computer program including instructions which, when executed by at least one processor, causes the at least one processor to carry out the functionality of the network node according to any of the embodiments described herein is provided. In some embodiments, a carrier comprising the aforementioned computer program product is provided. The carrier is one of an electronic signal, an optical signal, a radio signal, or a computer-readable storage medium (e.g., a non-transitory computer-readable medium such as memory).

FIG. 13 is a schematic block diagram of the network node 1200 according to some other embodiments of the present disclosure. The network node 1200 includes one or more modules 1300, each of which is implemented in software. The module(s) 1300 provide the functionality of the network node 1200 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a wireless communication device for wireless transmission using Frequency Shift Keying (FSK), modulation within a frequency band or guard band of an Orthogonal Frequency Division Multiplexing (OFDM), carrier, the method comprising:
identifying configuration parameters for FSK modulation based on one or more parameters related to a numerology of an OFDM carrier such that the FSK modulation has continuous phase;
applying the FSK modulation to an input signal in accordance with the configuration parameters identified for the FSK modulation to produce an FSK-modulated signal; and
transmitting the FSK-modulated signal within either a frequency band of the OFDM carrier or a guard band of the OFDM carrier.

2. The method of claim 1, wherein the configuration parameters for the FSK modulation comprise carrier frequency, symbol duration, modulation index, or any combination of two or more thereof.

3. The method of claim 1, wherein one or more of the configuration parameters for the FSK modulation are stored at the wireless communication device.

4. The method of claim 1, further comprising:
receiving, from a network node, signaling indicating the one or more parameters related to the numerology of the OFDM carrier.

5. The method of claim 1, wherein identifying the configuration parameters for the FSK modulation comprises:
identifying the configuration parameters for the FSK modulation from among a plurality of sets of configuration parameters stored at the wireless communication device based on the one or more parameters related to the numerology of the OFDM carrier.

6. The method of claim 1, wherein identifying the configuration parameters for the FSK modulation comprises:
computing one or more of the configuration parameters for the FSK modulation based on the one or more parameters related to the numerology of the OFDM carrier.

7. The method of claim 1, wherein the one or more parameters related to the numerology of the OFDM carrier comprise either or both of a subcarrier spacing and a channel raster.

8. The method of claim 1, wherein the configuration parameters for the FSK modulation are such that:
a peak frequency deviation for the FSK-modulated signal is a positive integer multiple of half a subcarrier spacing of the OFDM carrier;
a product of the symbol duration of the FSK-modulated signal and the peak frequency deviation is an integer; and
the carrier frequency of the FSK-modulated signal is an average of two adjacent subcarrier frequencies of the OFDM carrier.

9. The method of claim 1, wherein the configuration parameters for the FSK modulation are such that:
a peak frequency deviation for the FSK-modulated signal is one half of a subcarrier spacing of the OFDM carrier plus k times the subcarrier spacing of the OFDM carrier, wherein k is an integer that is greater than or equal to 0;
the symbol duration of the FSK-modulated signal is j times twice an OFDM symbol duration of the OFDM carrier, wherein j is an integer that is greater than or equal to 1; and
the carrier frequency of the FSK-modulated signal is an average of two adjacent subcarrier frequencies of the OFDM carrier.

10. The method of claim 1, wherein the configuration parameters for the FSK modulation are such that:
a peak frequency deviation for the FSK-modulated signal is one half of a subcarrier spacing of the OFDM carrier;
the symbol duration of the FSK-modulated signal is twice an OFDM symbol duration of the OFDM carrier; and
the carrier frequency of the FSK-modulated signal is an average of two adjacent subcarrier frequencies of the OFDM carrier.

11. The method of claim 1, wherein the configuration parameters for the FSK modulation are such that:
a modulation alphabet for the FSK modulation is {−K_1, . . . , 0, 1, . . . , K_2} wherein K1 and K2 are non-negative;
the carrier frequency of the FSK-modulated signal is equal to a center frequency of one of a plurality of subcarriers of the OFDM carrier;
the modulation index for the FSK-modulated signal is even; and
the symbol duration of the FSK-modulated signal is a multiple of an OFDM symbol duration of the OFDM carrier.

12. The method of claim 1, wherein the configuration parameters for the FSK modulation are such that:
a modulation alphabet for the FSK modulation is {0,1};
the carrier frequency of the FSK-modulated signal is equal to a center frequency of one of a plurality of subcarriers of the OFDM carrier;
the modulation index for the FSK-modulated signal is even; and
the symbol duration of the FSK-modulated signal is a multiple of an OFDM symbol duration of the OFDM carrier.

13. The method of claim 1, wherein the wireless communication device is one of a plurality of wireless communication devices transmitting to an OFDM receiver in the frequency band or guard band of the OFDM carrier, and a portion of the frequency band or guard band of the OFDM carrier in which the FSK-modulated signal is transmitted is based on a frequency synchronization accuracy of the wireless communication device.

14. (canceled)

15. A wireless communication device for wireless transmission using Frequency Shift Keying (FSK), modulation within a frequency band or guard band of an Orthogonal Frequency Division Multiplexing (OFDM), carrier, the wireless communication device comprising:
a transmitter; and
processing circuitry associated with the transmitter, the processing circuitry configured to cause the wireless communication device to:
identify configuration parameters for FSK modulation based on one or more parameters related to a numerology of an OFDM carrier such that the FSK modulation has continuous phase;
apply the FSK modulation to an input signal in accordance with the configuration parameters identified for the FSK modulation to produce an FSK-modulated signal; and
transmit (908) the FSK-modulated signal within either a frequency band of the OFDM carrier or a guard band of the OFDM carrier.

16. (canceled)

17. A method performed by a network node comprising an Orthogonal Frequency Division Modulation (OFDM) receiver for wireless reception using Frequency Shift Keying (FSK) modulation within a frequency band or guard band of an OFDM carrier, the method comprising:
receiving, from a wireless communication device via the OFDM receiver, an FSK-modulated signal within either a frequency band of the OFDM carrier or a guard band of the OFDM carrier, wherein the FSK-modulated signal is modulated in accordance with a continuous phase FSK modulation scheme having one or more configuration parameters that are based on one or more parameters related to a numerology of the OFDM carrier; and
applying FSK demodulation to the FSK-modulated signal to produce an output signal.

18.-19. (canceled)

20. The method of claim 17, further comprising:
transmitting signaling indicating the one or more parameters related to the numerology of the OFDM carrier to the wireless communication device to enable the wireless communication device to identify the one or more configuration parameters for the continuous phase FSK modulation scheme;
wherein transmitting the signaling indicating the one or more parameters related to the numerology of the OFDM receiver to the wireless communication device further comprises:
transmitting signaling indicating the one or more parameters related to the numerology of the OFDM receiver to a network node.

21. (canceled)

22. The method of claim 17, wherein a portion of the frequency band or guard band of the OFDM carrier in which the FSK-modulated signal is received is based on a frequency synchronization accuracy of the wireless communication device.

23. The method of any of claim 17, wherein the wireless communication device is one of a plurality of wireless communication devices and the plurality of wireless communication devices is divided into two or more groups based on the frequency synchronization accuracy of the wireless communication device of the plurality of wireless communication devices, wherein the two or more groups are assigned to different portions of the frequency band of the OFDM carrier.

24. The method of claim 23, wherein the two or more groups are separated in frequency by one or more guard bands.

25. The method of claim 23, wherein a first group of the two or more groups includes wireless communication devices with a frequency synchronization accuracy less than C₁ parts per million, ppm, a second group of the two or more groups includes wireless communication devices with a frequency synchronization accuracy greater than or equal to C₁ ppm and less than C₂ ppm, and a third group of the two or more groups includes wireless communication devices with a frequency synchronization accuracy greater than C₂ ppm.

26.-28. (canceled)
